(19) United States
(12) Patent Application Publication
(10) Pub. No.: US 2026/0072269 A1
(43) Pub. Date: Mar. 12, 2026

(54) LENS STACK AIR-CAVITY MOISTURE CONTROL

(71) Applicant: Applied Materials, Inc., Santa Clara, CA (US)

(72) Inventors: Daniel Robert ADEMA, Kitchener (CA); Neal RICKS, San Jose, CA (US); Kazuya DAITO, Milpitas, CA (US)

(21) Appl. No.: 19/320,947

(22) Filed: Sep. 5, 2025

Related U.S. Application Data
(60) Provisional application No. 63/691,846, filed on Sep. 6, 2024.

(51) Int. Cl. G02B 27/00

(52) U.S. Cl. CPC G02B 27/0006

(57) ABSTRACT

Embodiments of the present disclosure relate to optical devices. More specifically, embodiments described herein have a lens stack including a waveguide, the lens stack having at least one surface partially coated with a hydrophobic and/or hydrophobic coating. In some embodiments, the hydrophobic and/or hydrophilic coatings are disposed over portions of the waveguide surface. In some embodiments, the hydrophobic and/or hydrophilic coatings are disposed over portions of the lens surfaces. In some embodiments, hydrophobic coatings prevent moisture from interacting with certain surfaces on the waveguide and hydrophilic coatings direct moisture away from those certain surfaces.

### CROSS-REFERENCE TO RELATED APPLICATIONS

This Application claims the benefit of U.S. Provisional Application 63/691,846, filed on Sep. 6, 2024, which is incorporated by reference herein in its entirety.

### BACKGROUND

### Field

Embodiments of the present disclosure generally relate to waveguides and lens stacks including waveguides. More specifically, embodiments described herein relate to a waveguide and/or lens within a lens stack having hydrophilic and/or hydrophobic coatings disposed over at least one surface preventing moisture.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

Waveguides, such as augmented reality waveguides, are used to overlay virtual images over the ambient environment. Generated light is propagated through a waveguide until the light exits the waveguide and is overlaid on the ambient environment. A challenge occurs when moisture finds its way onto a surface of the waveguide.

Accordingly, what is needed in the art is a waveguide including hydrophilic and/or hydrophobic coatings on one or more surfaces of a waveguide or lens within a waveguide lens stack.

### SUMMARY

In one embodiment, a waveguide is provided. The waveguide includes a substrate having at least one grating, the at least one grating is disposed over a first surface of the substrate, a hydrophobic coating at least disposed adjacent to a top edge of the at least one grating relative to a user's eye, and a hydrophilic coating disposed over the first surface between the hydrophobic coating and an edge of the substrate.

In another embodiment, a device is provided. The device includes a first lens having an inner surface, a second lens having an inner surface, the inner surface of the first lens and the inner surface of the second lens at least partially define an internal cavity, and a waveguide disposed within the internal cavity, the waveguide including a substrate having at least one grating, the at least one grating is disposed over a first surface of the substrate; and a hydrophobic coating at least disposed adjacent to a top edge of the at least one grating relative to a user's eye.

In yet another embodiment, a device is provided. The device includes a first lens having an inner surface, a second lens having an inner surface, the inner surface of the first lens and the inner surface of the second lens at least partially define an internal cavity, and a waveguide disposed within the internal cavity, the waveguide including a substrate having at least one grating, the at least one grating is disposed over a first surface of the substrate, and a hydrophilic coating disposed over one or more of the first surface, the inner surface of the first lens, and the inner surface of the second lens.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a perspective, front view of a waveguide, according to certain embodiments.

FIG. 1B is a schematic, cross-sectional view of a lens stack including the waveguide of FIG. 1A, according to certain embodiments.

FIG. 2A is a perspective, front view of a waveguide, according to certain embodiments.

FIG. 2B is a schematic, cross-sectional view of a lens stack including the waveguide of FIG. 2A, according to certain embodiments.

FIG. 3A is a perspective, front view of a waveguide, according to certain embodiments.

FIG. 3B is a schematic, cross-sectional view of a lens stack including the waveguide of FIG. 3A, according to certain embodiments.

FIG. 4A is a perspective, front view of a waveguide, according to certain embodiments.

FIG. 4B is a schematic, cross-sectional view of a lens stack including the waveguide of FIG. 4A, according to certain embodiments.

FIG. 5 is a perspective, front view of a waveguide, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. More specifically, embodiments described herein relate to a lens stack including a waveguide, the lens stack having at least one surface partially coated with a hydrophobic and/or hydrophobic coating. In some embodiments, the hydrophobic and/or hydrophilic coatings are disposed over portions of the waveguide surface. In some embodiments, the hydrophobic and/or hydrophilic coatings are disposed over portions of the lens surfaces. In some embodiments, hydrophobic coatings prevent moisture from interacting with certain surfaces on the waveguide and hydrophilic coatings direct moisture away from those certain surfaces.

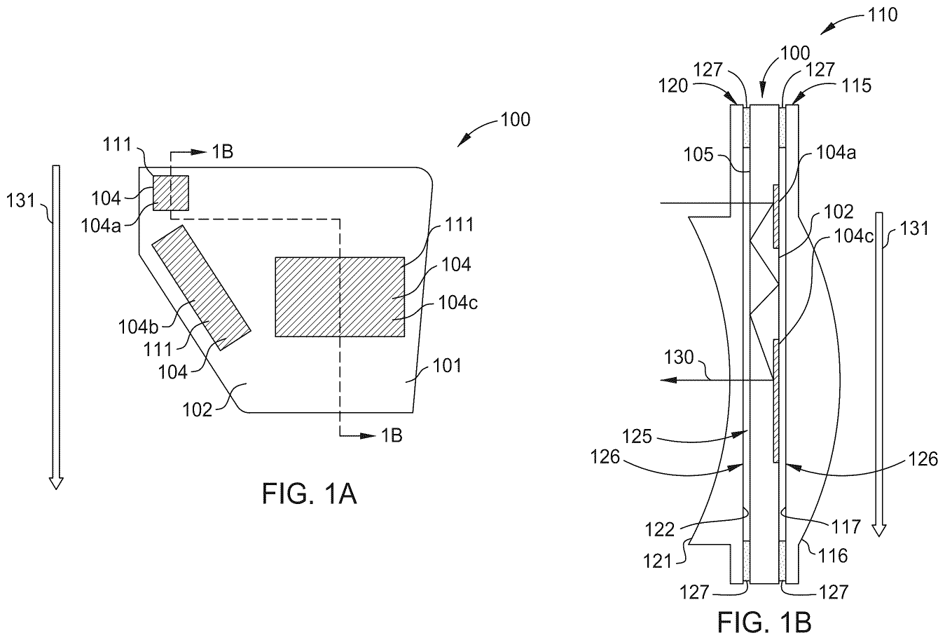

FIG. 1A is a perspective, front view of a waveguide 100. It is understood that the waveguide 100 described herein is an exemplary waveguide and that other waveguides may be used with or modified to accomplish aspects of the present disclosure. The waveguide 100 includes a plurality of structures 111. The structures 111 may be disposed over, under, or on a first surface 102 of a substrate 101, or disposed in the substrate 101. The structures 111 are nanostructures and have sub-micron critical dimensions (e.g., a width less than 1 micrometer). Regions of the structures 111 correspond to one or more gratings 104. In one embodiment, which can be combined with other embodiments described herein, the waveguide 100 includes at least a first grating 104a corresponding to an input coupling grating and a third grating 104c corresponding to an output coupling grating. In another embodiment, which can be combined with other embodiments described herein, the waveguide 100 further includes a second grating 104b. The second grating 104b corresponds to a pupil expansion grating or a fold grating.

The substrate 101 may also be selected to transmit a suitable amount of light of a desired wavelength or wavelength range, such as one or more wavelengths from about 100 to about 3000 nanometers. Without limitation, in some embodiments, the substrate 101 is configured such that the substrate 101 transmits greater than or equal to about 50% to about 100%, of an infrared to ultraviolet region of the light spectrum. The substrate 101 may be formed from any suitable material, provided that the substrate 101 can adequately transmit light in a desired wavelength or wavelength range and can serve as an adequate support for the waveguide 100 described herein. Substrate selection may include optical device substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the substrate 101 includes a transparent material. In one embodiment, which may be combined with other embodiments described herein, the substrate 101 is transparent with absorption coefficient smaller than 0.001. Suitable examples may include silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, lithium tantalate (LiTaO₃), lithium niobate (LiNbO₃), or combinations thereof. In some embodiments, which may be combined with other embodiments described herein, the substrate 101 has a substrate refractive index greater than 1.4, such as greater than 1.6, such as about 1.8, or about 2.0.

In some embodiments, the structures 111 are disposed in the substrate 101. In other embodiments, the structures 111 are disposed on or over the substrate 101. In these embodiments, the structures 111 include a device material. The device material includes, but is not limited to, silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SiN), silicon oxynitride (SiON), barium titanate (BaTiO₃), diamond like carbon (DLC), hafnium(IV) oxide (HfO₂), lithium niobate (LiNbO₃), silicon carbon-nitride (SiCN), or combinations thereof.

In operation of the waveguide 100 a virtual image is projected from a near-eye display, such as a microdisplay, to the first grating 104a. The structures 111 of the first grating 104a in-couple the incident beams of light of the virtual image and diffract the incident beams to the second grating 104b. The diffracted beams undergo total-internal-reflection (TIR) until through the waveguide 100 until the diffracted beams come in contact with structures 111 of the second grating 104b. The diffracted beams from the first grating 104a incident on the second grating 104b are split into a first portion beams refracted back or lost in the waveguide 100, a second portion beams that undergo TIR in the second grating 104b until the second portion beams contact another structure of the plurality of structures 111 of the second grating 104b, and a third portion of beams that are coupled through the waveguide 100 to the third grating 104c. The beams of the second portion of beams that undergo TIR in the second grating 104b continue to contact structures of the plurality of structures until the either the intensity of the second portion of beams coupled through the waveguide 100 to the second grating 104b is depleted, or remaining second portion of beams propagating through the second grating 104b reach the end of the second grating 104b.

The beams pass through the waveguide 100 to the third grating 104c and undergo TIR in the waveguide 100 until the beams contact a structure of the plurality of gratings 104 of the third grating 104c where the beams are split into beams that are refracted back or lost in the waveguide 100, beams that undergo TIR in the third grating 104c until the beams contact another structure of the plurality of gratings 104, or beams that are out-coupled from the waveguide 100 to the user's eye. The beams that undergo TIR in the third grating 104c continue to contact structures of the plurality of gratings 104 until the either the intensity of the beams pass through the waveguide 100 to the third grating 104c is depleted, or remaining beams propagating through the third grating 104c have reached the end of the third grating 104c. The beams of the virtual image are propagated from the third grating 104c to overlay the virtual image over the ambient environment.

FIG. 1B is a schematic, cross-sectional view of a lens stack 110 including the waveguide 100 of FIG. 1A. The lens stack 110 includes a first lens 115 including an outer surface 116 and an inner surface 117 and a second lens 120 including an outer surface 121 and an inner surface 122. The inner surface 117 of the first lens 115 and the inner surface 122 of the second lens 120 at least partially define an internal cavity 125. The lens stack 110 further includes the waveguide 100 disposed between the first lens 115 and the second lens 120 in the internal cavity 125. In some embodiments, which may be combined with other embodiments described herein, airgaps 126 are formed between the first lens 115 and the waveguide 100 and between the second lens 120 and the waveguide 100. That is, the inner surface 117 of the first lens 115 is spaced from the first surface 102 of the waveguide 100 and an inner surface 122 of the second lens 120 is spaced from a second surface 105 of the waveguide 100. In some embodiments, which can be combined with other embodiments described herein, the waveguide 100 is coupled to the first lens 115 and the second lens 120 by adhesive 127. The first grating 104a and third grating 104c are illustrated as disposed in the first surface 102 of the waveguide 100, however, they may be formed on the first surface 102 of the waveguide 100.

In operation, moisture can occasionally find its way into the lens stack 110. In some instances, the moisture may form due to condensation. In some instances, the moisture may form or find its way onto any of the internal surfaces (e.g., surfaces 102, 105, 117, and 122) of the lens stack 110. When moisture is disposed on the internal surfaces, the moisture may negatively affect light propagation (illustrated by arrow 130 in FIG. 1B) through the lens stack 110. In typical operation, as shown by arrow 130, light enters through the input coupling grating (e.g., the first grating 104a) and propagates through the lens stack 110 to the output coupling grating (e.g., the third grating 104c), and the light is then out-coupled from the waveguide 100 to the user's eye. However, if moisture accumulates on any of the internal surfaces and/or one or more of the gratings 104, the light propagation may be interrupted. The direction of gravity is annotated as arrow 131. The moisture accumulating on the internal surfaces (e.g., surfaces 102, 105, 117, and 122) of the lens stack 110 is subject to gravity. Accordingly, without being bound by theory, the moisture can travel in the direction of arrow 131. If moisture travels in the direction of arrow 131 and accumulates on the internal surfaces (e.g., surfaces 102, 105, 117, and 122) of the lens stack 110 in which, or upon which light is propagating, light propagation is interrupted.

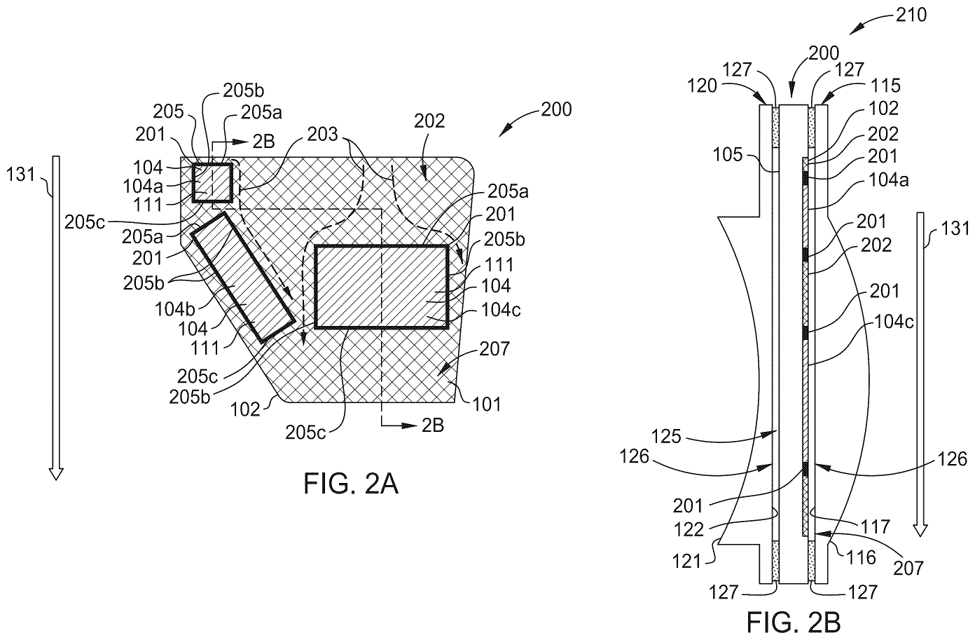

FIG. 2A is a perspective, front view of a waveguide 200. FIG. 2B is a schematic cross-sectional view of a lens stack 210 including the waveguide 200 of FIG. 2A.

The waveguide 200 includes a hydrophobic coating 201. In one or more embodiments, the hydrophobic coating 201 coats (e.g., is disposed on) at least a portion of the first surface 102 of the waveguide 200. In some embodiments, which may be combined with other embodiments described herein, the areas of the first surface 102 coated in the hydrophobic coating 201 are localized to portions of the first surface 102 (as illustrated). The hydrophobic coating 201 causes the coated surface to repel moisture and effectively creates a hydrophobic barrier preventing moisture from flowing through said barrier. In some embodiments, the hydrophobic coating 201 may be disposed on top of another coating on the first surface 102. In one or more of such embodiments, the other coating may be a silicon-oxide layer.

In some embodiments, which can be combined with other embodiments described herein, the hydrophobic coating 201 may have a refractive index that is substantially similar to the refractive index of the substrate 101. In some embodiments, which may be combined with other embodiments described herein, the substrate 101 has a substrate refractive index greater than 1.4, such as greater than 1.6, such as about 1.8, or about 2.0. In some embodiments, the refractive index of the hydrophobic coating 201 is less than about 40% of the refractive index of the substrate 101. In some embodiments, the substrate refractive index and the hydrophobic coating 201 refractive index are substantially the same.

The waveguide 200 also includes a hydrophilic coating 202. In one or more embodiments, the hydrophilic coating 202 coats (e.g., is disposed on) at least a portion of the first surface 102 of the waveguide 200. In some embodiments, which may be combined with other embodiments described herein, the areas of the first surface 102 coated in the hydrophilic coating 202 are localized to portions of the first surface 102 (as illustrated). Without being bound by theory, the hydrophilic coating 202 prevents moisture from accumulating on the coated portion of the first surface 102 by allowing moisture to flow across the first surface 102 thereby providing a path 203 for moisture. Accordingly, the hydrophilic coating 202 provides a path 203 for moisture on the first surface 102 and the hydrophobic coating 201 repels moisture from specific areas of the first surface 102 of the waveguide 200. In some embodiments, the hydrophilic coating 202 may be disposed on top of another coating on the first surface 102. In one or more of such embodiments, the other coating may be a silicon-oxide layer.

In some embodiments, which can be combined with other embodiments described herein, the hydrophilic coating 202 may have a refractive index that is substantially similar to the refractive index of the substrate 101. In some embodiments, which may be combined with other embodiments described herein, the substrate 101 has a substrate refractive index greater than 1.4, such as greater than 1.6, such as about 1.8, or about 2.0. In some embodiments, the refractive index of the hydrophilic coating 202 is less than about 40% of the refractive index of the substrate 101. In some embodiments, the substrate refractive index and the hydrophilic coating 202 refractive index are substantially the same.

The hydrophobic coating 201 creates hydrophobic boundaries around portions of the first surface 102. As shown, the hydrophobic coating 201 creates a hydrophobic boundary at one or more edges 205 of the gratings 104. In some embodiments, which may be combined with other embodiments described herein, the hydrophobic coating is adjacent to one or more edges 205 of the gratings 104. Herein, adjacent could mean adjacent and abutting edge 205 but could also mean adjacent to the edge 205 but with a gap between the hydrophobic coating 201 and the edge 205. According to some embodiments, which can be combined with other embodiments described herein, and as illustrated, the hydrophobic coating 201 is adjacent to more than one edge 205 of the gratings 104. According to one or more non-limiting examples, the hydrophobic coating 201 may be disposed adjacent to one, two, three, four, and/or all of the edges 205 of the gratings 104. As illustrated, the hydrophobic coating 201 is disposed on all sides of the gratings 104 (e.g., the hydrophobic coating 201 surrounds each of the gratings 104). In some embodiments, the hydrophobic coating 201 creates a hydrophobic barrier extending across a top edge 205a of the first grating 104a. In some embodiments, the hydrophobic coating 201 also creates a hydrophobic barrier extending across one or more of a top edge 205a of the second grating 104b and a top edge 205a of the third grating 104c. The top edges 205a are the top edge 205a of the gratings 104 relative to a user's eye. As described herein, gravity is normal or near-normal to the user's eye (i.e., the incident light to the first grating 104a is normal or near-normal to gravity). In some embodiments, the top edges 205a are top edges relative to the direction of incident light. In some embodiments, such as the illustrated embodiment, the hydrophobic barrier extends down one or more of the side edges 205b of the first grating 104a, the side edges 205b of the second grating 104b, and the side edges 205b of the third grating 104c. In some embodiments, such as the illustrated embodiment, the hydrophobic barrier extends across one or more of the bottom edge 205c of the first grating 104a, the bottom edge 205c of the second grating 104b, and the bottom edge 205c of the third grating 104c. Accordingly, moisture is prevented from entering the gratings 104 from any direction. In some embodiments, which may be combined with other embodiments described herein, the hydrophobic barriers (created by the hydrophobic coating 201) includes sloped or rounded edges to urge moisture flow around the hydrophobic barriers.

The hydrophilic coating 202 is disposed on at least a portion of the first surface 102 of the waveguide 200 not including the hydrophobic coating 201. For example, as illustrated, the hydrophilic coating 202 may be disposed on the remainder of the first surface 102. In some embodiments, the hydrophilic coating 202 is disposed on the first surface 102 between the hydrophobic coating 201 and the edge of the waveguide 200. The hydrophilic coating 202 creates moisture paths 203 through the lens stack 210 and around the gratings 104. In operation, gravity (as shown by arrow 131) in conjunction with the hydrophilic coating 202 causes the accumulated moisture to flow down along moisture paths 203. Accordingly, the moisture does not accumulate on the internal surfaces (e.g., surfaces 102, 105, 117, and 122) within the lens stack 210. Further, the hydrophobic coating 201 prevents the moisture from accumulating on and/or flowing over the gratings 104. In some embodiments, the hydrophobic barrier created by the hydrophobic coating 201 includes sloped, rounded, or curved edges to direct moisture away from the gratings 104. As the moisture flows to the bottom of the lens stack 210 (e.g., the bottom as defined by gravity and generally area 207 as shown in FIGS. 2A-2B), the moisture may be vented out of the lens stack by, for instance, microfluidic vents (e.g., one-way flow vents configured to permit moisture egress while preventing fluid ingress). As described herein, gravity is normal or near-normal to the user's eye or the user's eye. I.e., the incident light to the first grating 104a is normal or near-normal to gravity.

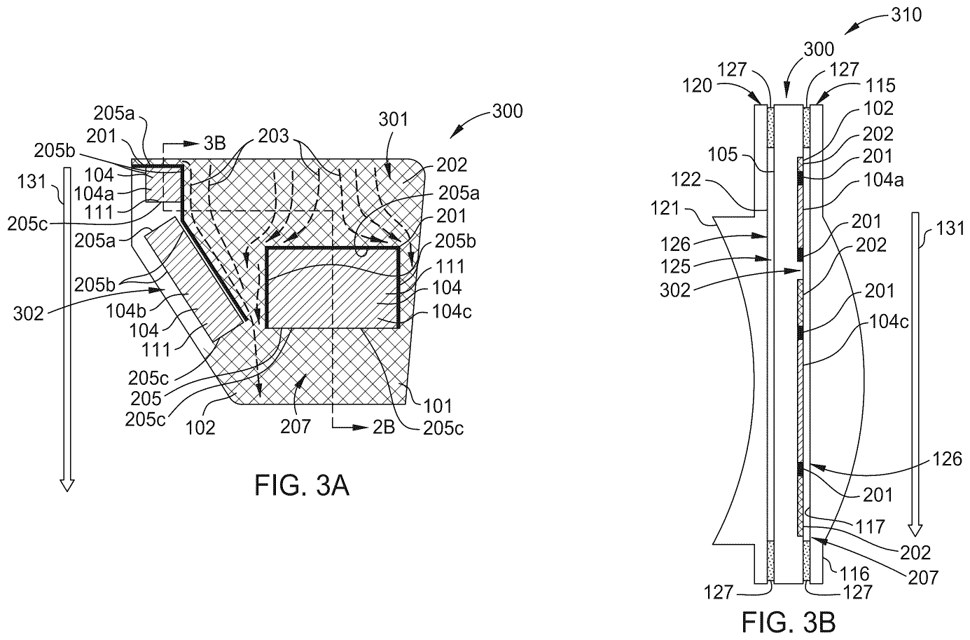

FIG. 3A is a perspective, front view of another waveguide 300. FIG. 3B is a schematic cross-sectional view of a lens stack 310 including the waveguide 300 of FIG. 3A.

The lens stack 310 includes a first lens 115, a second lens 120, and a waveguide 300 disposed within an internal cavity 125 at least partially defined by an inner surface 117 of the first lens 115 and an inner surface 122 of the second lens 120. Lens stack 310 includes similar components and features to those included in lens stack 210. Accordingly, for the sake of brevity, a description of like features will not be described herein.

In some embodiments, such as the embodiment illustrated in FIGS. 3A-3B, the hydrophobic coating 201 disposed on the first surface 102 of the waveguide 300 partially surrounds the gratings 104 of waveguide 300. The hydrophobic coating 201 creates a hydrophobic barrier extending across at least a top edge 205a of the first grating 104a. The top edges 205a are the top edge 205a of the gratings 104 relative to a user's eye. As described herein, gravity is normal or near-normal to the user's eye (i.e., the incident light to the first grating 104a is normal or near-normal to gravity) . In some embodiments, the top edges 205a are top edges relative to the direction of incident light. In some embodiments, such as the illustrated embodiment, the hydrophobic barrier extends down a side edge 205b of the first grating 104a and the side edge 205b of the second grating 104b. Further, the hydrophobic coating 201 creates a hydrophobic barrier extending across a top edge 205a of the third grating 104c. In some embodiments, the hydrophobic coating 201 creates a hydrophobic barrier extending down the side edges 205b of the third grating 104c. Accordingly, the hydrophobic coating 201 provides hydrophobic barriers protecting the top edges 205a and side edges 205b of the gratings 104 from moisture. Without being bound by theory, accumulating moisture will flow in the direction of gravity (along arrow 131). Example moisture paths are illustrated as moisture paths 203. Without being bound by theory, because moisture is flowing in the direction of gravity, the bottom facing edges 205c of the gratings 104 will not be exposed to moisture ingress.

In some embodiments, such as the embodiment illustrated in FIGS. 3A-3B, the hydrophilic coating 202 is disposed on at least a portion of the first surface 102 of the waveguide 300 not including the hydrophobic coating 201. For example, as illustrated, the hydrophilic coating 202 is disposed on a portion 301 of the first surface 102 of the waveguide 300. The portion 301 may be between the hydrophobic coating 201 and the edge of the waveguide 300. The hydrophilic coating 202 creates moisture paths 203 through the lens stack 210 and around the gratings 104. In operation, gravity (as shown by arrow 131) in conjunction with the hydrophilic coating 202 causes the accumulated moisture to flow down along moisture paths 203. Accordingly, the moisture does not accumulate on the internal surfaces (e.g., surfaces 102, 105, 117, and 122) within the lens stack 210. Further, the hydrophobic coating 201 prevents the moisture from accumulating on and/or flowing over the gratings 104. As the moisture flows to the bottom of the lens stack 210 (e.g., the bottom as defined by gravity and generally area 207 as shown in FIGS. 3A-3B), the moisture may be vented out of the lens stack by, for instance, microfluidic vents (e.g., one-way flow vents configured to permit moisture egress while preventing fluid ingress).

In some embodiments, such as the illustrated embodiment, a second portion 302 of the first surface 102 remains uncoated (hereinafter referred to as “uncoated portion 302”) by the hydrophilic coating 202 (and the hydrophobic coating 201). In some embodiments, which may be combined with other embodiments described herein, the uncoated portion 302 may be a portion of first surface 102 that is protected from moisture due to the hydrophobic barrier created by the hydrophobic coating 201 and due to gravity. That is, because moisture falls with gravity along moisture paths 203, and because the hydrophobic coating 201 creates a hydrophobic barrier, the moisture may not flow across the uncoated portion 302. In one or more embodiments, such as the illustrated embodiment, the portion 301 and uncoated portion 302, may not be completely partitioned by the hydrophobic barrier (e.g., hydrophobic coating 201). In one or more embodiments, such as the illustrated embodiment, the portion 301 and uncoated portion 302, may be completely partitioned by the hydrophobic barrier (e.g., hydrophobic coating 201).

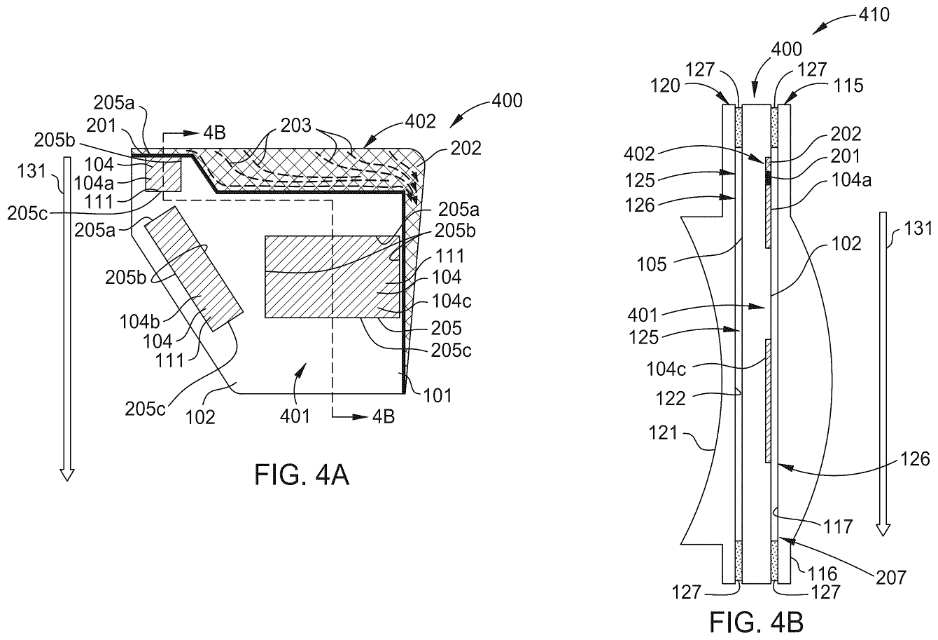

FIG. 4A is a perspective, front view of another waveguide 400. FIG. 4B is a schematic cross-sectional view of a lens stack 410 including the waveguide 400 of FIG. 4A.

The lens stack 410 includes a first lens 115, a second lens 120, and a waveguide 400 disposed within an internal cavity 125 at least partially defined by an inner surface 117 of the first lens 115 and an inner surface 122 of the second lens 120. Lens stack 410 includes similar components and features to those included in lens stack 310 (and lens stack 210). Accordingly, for the sake of brevity, a description of like features will not be described herein.

In some embodiments, such as the embodiment illustrated in FIGS. 4A-4B, a hydrophobic coating 201 disposed on the first surface 102 of the waveguide 300 partially surrounds the gratings 104 of waveguide 300. The hydrophobic coating 201 creates a hydrophobic barrier between a first portion 401 of the first surface 102 and a second portion 402 of the first surface 102 (e.g., dividing the first surface 102 into the first portion 401 and second portion 402). The first portion 401 includes the gratings 104. Accordingly, the first portion 401 including the gratings 104 includes a hydrophobic barrier which prevents moisture from entering the first portion 401. In some embodiments, which can be combined with other embodiments, the first portion 401 is disposed below (in the direction of gravity) the second portion 402. Thus, without being bound by theory, moisture accumulating and flowing downward with gravity comes into contact with the hydrophobic barrier and is prevented from flowing further downward into the first portion 401.

In some embodiments, which can be combined with other embodiments described herein, the first portion 401 also includes areas between the gratings 104. Without being bound by theory, as light propagates from the first grating 104a to the third grating 104c, light propagates between the gratings 104. Accordingly, by preventing moisture from flowing through and/or accumulating in the areas between the gratings 104, moisture is prevented from interfering with light propagation between the gratings 104.

In some embodiments, such as the embodiment illustrated in FIGS. 4A-4B, the hydrophilic coating 202 is disposed on a portion of the first surface 102 of the waveguide 400. In some embodiments, the hydrophilic coating 202 is disposed on the second portion 402 of the first surface 102 not including the gratings 104. In some embodiments, the hydrophilic coating 202 is disposed between the hydrophobic coating 201 and the edge of the waveguide 400. The hydrophilic coating 202 creates moisture paths 203 through the lens stack 210. In operation, gravity (as shown by arrow 131) in conjunction with the hydrophilic coating 202 causes the accumulated moisture to flow down along moisture paths 203. As described herein, gravity is normal or near-normal to the user's eye. I.e., the incident light to the first grating 104a is normal or near-normal to gravity. Accordingly, the moisture does not accumulate on the internal surfaces (e.g., surfaces 102, 105, 117, and 122) within the lens stack 210. Further, the hydrophobic coating 201 prevents the moisture from accumulating on and/or flowing into the first portion 401 including the gratings 104. As the moisture flows to the bottom of the lens stack 210 (e.g., the bottom as defined by gravity and generally area 207 as shown in FIGS. 4A-4B), the moisture may be vented out of the lens stack by, for instance, microfluidic vents (e.g., one-way flow vents configured to permit moisture egress while preventing fluid ingress).

In some embodiments, such as the illustrated embodiment, the first portion 401 of the first surface 102 (e.g., the portion including the gratings 104) does not include the hydrophilic coating 202 and the hydrophobic coating 201. In some embodiments, which may be combined with other embodiments described herein, this may be because the first portion 401 is protected from moisture due to the hydrophobic barrier created by the hydrophobic coating 201 and due to gravity. That is, because moisture falls with gravity along moisture paths 203, and because the hydrophobic coating 201 creates a hydrophobic barrier, the moisture may not flow into the first portion 401.

In some embodiments, which may be combined with other embodiments described herein, the waveguide 400 illustrated in FIGS. 4A-4B (and other waveguides described herein such as waveguides 100, 200, and 300) does not include a hydrophobic coating 201 and, rather, the hydrophobic boundary is defined by an edge of the hydrophilic coating 202. According to one non-limiting example, in waveguide 400, the boundary between the first portion 401 and the second portion 402 is defined by the edge of the hydrophilic coating 202.

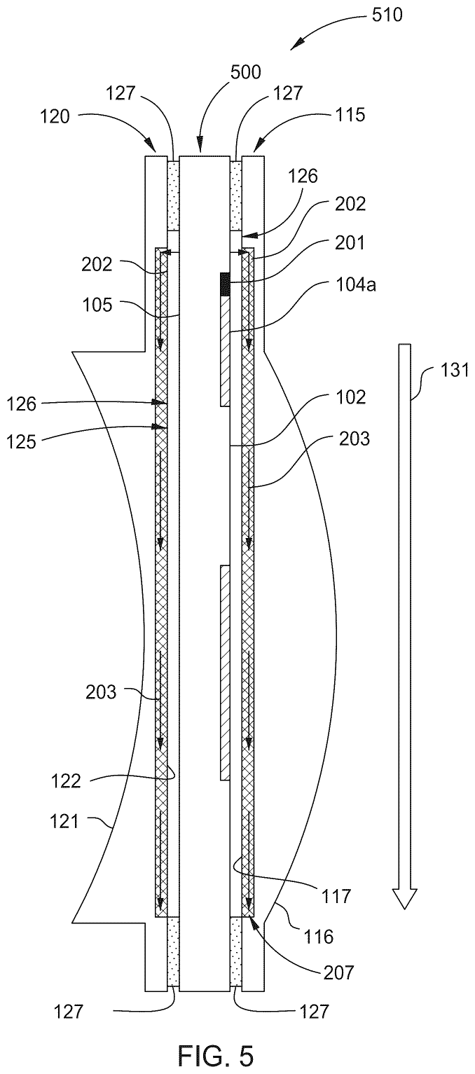

FIG. 5 is a schematic cross-sectional view of another lens stack 510. The lens stack 510 includes a first lens 115, a second lens 120, and a waveguide 500 disposed within an internal cavity 125 at least partially defined by an inner surface 117 of the first lens 115 and an inner surface 122 of the second lens 120. Lens stack 510 includes similar components and features to those included in lens stack 410 (and lens stacks 310 and 210). Accordingly, for the sake of brevity, a description of like features will not be described herein.

In some embodiments, one or more of the inner surface 117 of the first lens 115 and the inner surface 122 of the second lens 120 may include a hydrophobic coating 201 and/or a hydrophilic coating 202. For example, as shown, the inner surface 117 of the first lens 115 and the inner surface 122 of the second lens 120 include a hydrophilic coating 202. Without being bound by theory, including a hydrophilic coating 202 on the inner surface 117 of the first lens 115 and the inner surface 122 of the second lens 120 may direct moisture away from the gratings 104 on the first surface 102 of the waveguide 500.

In some embodiments, such as the illustrate embodiment, the waveguide 500 also includes one or more of a hydrophobic coating 201 and hydrophilic coating 202 on the first surface 102 and/or the second surface 105. As shown, the waveguide 500 can include a hydrophobic coating 201 on the first surface 102 and the second surface 105 creating a hydrophobic boundary above the gratings 104. Without being bound by theory, the hydrophobic coating 201 disposed above the gratings 104 may repel moisture such that moisture is directed from the first surface 102 to the inner surface 117 of the first lens 115 and from the second surface 105 to the inner surface 122 of the second lens 120. Once moisture is directed from the waveguide surfaces to the inner surfaces of the lenses, the moisture is allowed to flow along path 203 in the direction of gravity (shown as arrow 131) due to gravity and due to the hydrophilic coating 202 on the lenses. As described herein, gravity is normal or near-normal to the user's eye. I.e., the incident light to the first grating 104a is normal or near-normal to gravity. Without being bound by theory, the moisture is thus permitted to flow downward and around the gratings 104.

Benefits of the present disclosure include improved moisture handling in lens stacks including waveguides. Specifically, benefits of the present disclosure include preventing moisture from affecting light propagation through lens stacks. Moisture accumulation within lens stacks on, within, or between light handling structures (such as gratings) can adversely affect light propagation and total-internal-reflection (TIR) through the lens stack. By including hydrophilic and/or hydrophobic coatings on one or more internal surfaces of the lens stack, moisture accumulation can be beneficially controlled to minimize adverse effects on light propagation and TIR through the lens stack. As an example, the inclusion of hydrophilic and/or hydrophobic coatings may beneficially direct accumulated moisture away from light handling surfaces and structures within lens stacks.

It is contemplated that one or more aspects disclosed herein may be combined. As an example, one or more aspects, features, components, operations and/or properties of waveguide 100, lens stack 110, waveguide 200, lens stack 210, waveguide 300, lens stack 310, waveguide 400, lens stack 410, waveguide 500, and lens stack 510 may be combined, in whole or in part, with one or more aspects, features, components, operations, and/or properties of waveguide 100, lens stack 110, waveguide 200, lens stack 210, waveguide 300, lens stack 310, waveguide 400, lens stack 410, waveguide 500, and lens stack 510. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
a substrate having at least one grating, the at least one grating is disposed over a first surface of the substrate;
a hydrophobic coating at least disposed adjacent to a top edge of the at least one grating relative to a user's eye; and
a hydrophilic coating disposed over the first surface between the hydrophobic coating and an edge of the substrate.

2. The waveguide of claim 1, wherein the hydrophobic coating is disposed adjacent to a side edge of the at least one grating.

3. The waveguide of claim 1, wherein the hydrophobic coating surrounds the at least one grating.

4. The waveguide of claim 1, further comprising a second grating.

5. The waveguide of claim 1, wherein the hydrophobic coating creates a hydrophobic boundary dividing the first surface into a first portion and a second portion, the first portion including the at least one grating.

6. The waveguide of claim 5, wherein the second portion of the first surface includes the hydrophilic coating.

7. A device, comprising:
a first lens having an inner surface;
a second lens having an inner surface, wherein the inner surface of the first lens and the inner surface of the second lens at least partially define an internal cavity; and
a waveguide disposed within the internal cavity, the waveguide including:
a substrate having at least one grating, the at least one grating is disposed over a first surface of the substrate; and
a hydrophobic coating at least disposed adjacent to a top edge of the at least one grating relative to a user's eye.

8. The device of claim 7, wherein the hydrophobic coating is disposed adjacent to a side edge of the at least one grating.

9. The device of claim 8, wherein the waveguide further includes a hydrophilic coating disposed over the first surface between the hydrophobic coating and an edge of the substrate.

10. The device of claim 7, wherein the hydrophobic coating creates a hydrophobic boundary dividing the first surface into a first portion and a second portion, the first portion including the at least one grating.

11. The device of claim 10, wherein a hydrophilic coating is disposed over the second portion of the first surface.

12. The device of claim 7, wherein the device further comprises a hydrophilic coating disposed over one or more of the inner surface of the first lens, and the inner surface of the second lens.

13. The device of claim 12, wherein the hydrophilic coating is disposed over the inner surface of the first lens and the inner surface of the second lens.

14. The device of claim 13, wherein the hydrophilic coating is further disposed over the first surface.

15. A device, comprising:
a first lens having an inner surface;
a second lens having an inner surface, the inner surface of the first lens and the inner surface of the second lens at least partially define an internal cavity; and
a waveguide disposed within the internal cavity, the waveguide including:
a substrate having at least one grating, the at least one grating is disposed over a first surface of the substrate; and
a hydrophilic coating disposed over one or more of the first surface, the inner surface of the first lens, and the inner surface of the second lens.

16. The device of claim 15, wherein the hydrophilic coating is disposed over the first surface, the inner surface of the first lens, and the inner surface of the second lens.

17. The device of claim 15, wherein the waveguide further includes a hydrophobic coating at least disposed adjacent to a top edge of the at least one grating relative to a user's eye.

18. The device of claim 17, wherein the hydrophobic coating is disposed adjacent to a side edge of the at least one grating.

19. The device of claim 17, wherein the hydrophobic coating creates a hydrophobic boundary dividing the first surface into a first portion and a second portion the first portion including the at least one grating.

20. The device of claim 19, wherein the second portion of the first surface includes the hydrophilic coating.
